(19) United States
(12) Patent Application Publication
(10) Pub. No.: US 2015/0134233 A1
(43) Pub. Date: May 14, 2015

(54) Systems and Methods for Identifying Traffic Intersection Restrictions

(71) Applicant: Google Inc., Mountain View, CA (US)

(72) Inventor: Daniel Wolf, Menlo Park, CA (US)

(73) Assignee: Google Inc., Mountain View, CA (US)

(21) Appl. No.: 13/731,933

(22) Filed: Dec. 31, 2012

(51) Int. Cl. G01C 21/34

(52) U.S. Cl. CPC G01C 21/3492
USPC 701/118

(57) ABSTRACT

Embodiments include a computer-implemented method for determining restrictions at an intersection of two roads. The method includes receiving location data from one or more devices used to traverse the intersection via a plurality of paths, identifying the plurality of paths through the intersection from the location data, classifying each of the plurality of paths through the intersection according to a type of path through the intersection, obtaining a count for a type of path through the intersection based on the plurality of classified paths, identifying a potential restriction for the type of path through the intersection based at least in part on the count of the plurality of paths of that type used to traverse the intersection, and storing the potential restriction for that type of path through the intersection in association with map feature data for the intersection.

### BACKGROUND OF THE INVENTION

1. Field of the Invention

Embodiments of this invention relate generally to geographic mapping industries and, more particularly, to special purpose machines, systems, methods and computer instructions for identifying traffic restrictions.

2. Description of the Related Art

Persons often use geographic maps for locating points of interest (e.g., businesses, landmarks, etc.) and navigating to and from various locations. For example, a person may use a geographic map to identify a route for traveling between two cities, for traveling from their home to a local restaurant, or the like. With the advent of electronic maps, as well as electronic navigational assistance, persons are placing an increasing reliance on electronic maps and mapping services. For example, to locate a point of interest, such as a restaurant, a person may simply visit a mapping website, such as Google Maps (or a similar mapping application) and search for the restaurant. In many instances, electronic mapping services provide route guidance, such as suggested routes and directions for navigating to destination locations. For example, a mapping service may provide a geographic map illustrating a suggested route, accompanied by turn-by-turn directions corresponding thereto. Often, navigational assistance is provided in a static form, such as maps and a list of directions that can be printed by persons for reference while traveling to a destination location. In some instances, navigational assistance is provided in a dynamic form, such as real-time route guidance provided by a navigational device that accompanies a person while traveling. For example, a navigational device, such as a vehicle in-dash navigation unit or a cellular phone having a navigation application, may display a map of a suggested route, provide an indication of the person's current location, update the person's current location as they travel, and provide audible prompts (e.g., spoken turn-by-turn instructions) that assist the person in navigating the route.

With the increased reliance on electronic mapping services, users have come to expect that electronic maps and navigational assistance are accurate and reliable. Moreover, with regard to navigational assistance, users have come to expect that mapping services monitor various route conditions and provided navigational assistance that accounts for the route conditions. For example, it may be expected that navigational assistance applications take current traffic conditions (e.g., current traffic and road closures) into consideration when identifying suggested routes. Unfortunately, traffic conditions change on a regular basis and may be difficult to predict. For example, a road closure or other driving restriction (e.g., a turn restriction at a traffic intersection) may not be reported or readily apparent. As a result, a mapping service may be unaware of the restriction and, thus, the service's maps and its navigational assistance may be inaccurate or unreliable.

### SUMMARY OF THE INVENTION

Various embodiments of methods and apparatus for identifying and employing traffic intersection restrictions are provided herein. In some embodiments, provided is a computer-implemented method for determining restrictions at an intersection of two roads. The method includes receiving location data from one or more devices used to traverse the intersection via a plurality of paths, identifying the plurality of paths through the intersection from the location data, classifying each of the plurality of paths through the intersection according to a type of path through the intersection, obtaining a count for a type of path through the intersection based on the plurality of classified paths, identifying a potential restriction for the type of path through the intersection based at least in part on the count of the plurality of paths of that type used to traverse the intersection, and storing the potential restriction for that type of path through the intersection in association with map feature data for the intersection.

In some embodiments, provided is a system including one or more memories storing instructions and one or more processors coupled to the one or more memories and configured to execute the instructions stored thereon to perform the following steps for determining restrictions at an intersection of two roads: receiving location data from one or more devices used to traverse the intersection via a plurality of paths, identifying the plurality of paths through the intersection from the location data, classifying each of the plurality of paths through the intersection according to a type of path through the intersection, obtaining a count for a type of path through the intersection based on the plurality of classified paths, identifying a potential restriction for the type of path through the intersection based at least in part on the count of the plurality of paths of that type used to traverse the intersection, and storing the potential restriction for that type of path through the intersection in association with map feature data for the intersection.

In some embodiments, provided is a non-transitory computer readable medium comprising program instructions stored thereon that are executable by a processor to cause the following steps for determining restrictions at an intersection of two roads: receiving location data from one or more devices used to traverse the intersection via a plurality of paths, identifying the plurality of paths through the intersection from the location data, classifying each of the plurality of paths through the intersection according to a type of path through the intersection, obtaining a count for a type of path through the intersection based on the plurality of classified paths, identifying a potential restriction for the type of path through the intersection based at least in part on the count of the plurality of paths of that type used to traverse the intersection, and storing the potential restriction for that type of path through the intersection in association with map feature data for the intersection.

### BRIEF DESCRIPTION OF THE DRAWINGS

FIG. 1 is a flowchart that illustrates a method of identifying potential traffic intersection restrictions in accordance with one or more embodiments of the present invention.

FIGS. 2A and 2B are diagrams that illustrate location data and associated paths in accordance with one more embodiments of the present invention.

FIG. 3 is a diagram that illustrates various exemplary paths used to traverse an intersection in accordance with one more embodiments of the present invention.

FIG. 4 is a table that illustrates a log of intersection paths traversed in accordance with one or more embodiments of the present invention.

FIG. 5 is a flowchart that illustrates a method of updating traffic intersection restrictions in accordance with one or more embodiments of the present invention.

FIGS. 6A and 6B are tables that illustrate traffic intersection restrictions in accordance with one or more embodiments of the present invention.

FIG. 7 is a block diagram that illustrates a traffic information environment in accordance with one or more embodiments of the present invention.

FIG. 8 is a block diagram that illustrates an exemplary computer system in accordance with one or more embodiments of the present invention.

### DETAILED DESCRIPTION

As discussed in more detail below, provided are systems and methods for identifying and using traffic restrictions, including restrictions for traversing traffic intersections (“traffic intersection restrictions”). For example, the embodiments described herein may be employed to identify whether a particular turn at an intersection is unrestricted (e.g., legal or at least capable of being navigated easily), or is restricted (e.g., illegal or otherwise difficult to navigate). Such traffic intersection restrictions can be used in the context of navigational assistance to determine a suitable route for traversing an intersection. For example, where a user has requested navigational assistance for driving from their home to a restaurant, a mapping service may consider restrictions along potential routes between the user's home and the restaurant, and suggest a route that avoids restricted paths. For instance, despite a left-turn at an intersection providing the shortest route to the restaurant, if it is determined that the left-turn is restricted, the mapping service may suggest a route having a path straight through the intersection, and an unrestricted U-turn at the next intersection. Thus, the mapping service may route the user around traffic restrictions.

As described herein, traffic restrictions may be identified based on location data that is indicative of paths traveled by users. For example, certain embodiments include receiving location data from a plurality of users as they travel, identifying paths traversed by the users based at least in part on the location data, identifying how users traverse traffic intersections based on the identified paths, and identifying potential restrictions for the intersections (e.g., turn restrictions for the intersections) based at least in part on how users traverse the intersections.

In some embodiments, location data for a given user may include a series of geographic points (e.g., geographic coordinates—latitude and longitude coordinates) acquired from users' mobile devices. For example, location data for a user may be acquired from a user's mobile phone that accompanies the user as they travel. The geographic points may be used to identify paths that are traversed by the users. For example, a series of geographic coordinates that are acquired from a user's mobile phone as he/she travels from their home to a restaurant can be used to identify a path from the user's home to the restaurant. In some embodiments, paths that traverse intersections are assessed to identify traffic intersection restrictions. In some instances, a subset of the paths for a given intersection are identified based on their common entrance and exit locations. For example, all paths that traverse the intersection of Main St. and 1^{st} St. may be identified, and a subset of those paths that include an entry to the intersection from the South on Main St. and an exit from the intersection heading East on l^{st} St. (e.g., a northbound right turn from Main St. onto 1^{st} St.) may be grouped together. Similar groupings may be made for each intersection and each of the various entrance/exit pairs for the respective intersections. In some instances, the number or percentage of times that a path has been used to traverse the intersection can be used to determine whether the path is restricted in some way. For example, if a path that includes the northbound right turn from Main St. onto 1^{st} St. is traversed at least a threshold number or percentage of times, it may be determined that the a northbound right turn from Main St. onto 1^{st} St. is not restricted. In contract, however, if the path has not been traversed at least a threshold number or percentage of times, it may be determined that the northbound left turn from Main St. onto 1^{st} St. is potentially restricted (i.e., is illegal or at least difficult to navigate). A similar assessment can be repeated for any number of paths through the same intersection to identify any number of potential restrictions for the intersection. Moreover, the technique can be repeated for any number of intersections to identify potential traffic intersection restrictions through those intersections.

In some instances, potential restrictions can be compared to existing restrictions (i.e., restrictions that have previously been identified) to determine whether a conflict exists between the restrictions. For example, where a potential restriction for the northbound left turn from Main St. onto 1^{st} St. is identified, but a corresponding restriction is not identified in an existing/current set of restrictions for the intersection, the set of restrictions may be updated to include the restriction for the northbound left turn from Main St. onto 1^{st} St. In some instances potential restrictions are subjected to additional scrutiny to ensure they are valid before a corresponding change is made to an existing/current set of restrictions. For example, upon identifying a conflict between the potential restriction for the northbound left turn from Main St. onto 1^{st} St. and the existing/current set of restrictions (e.g., the existing/current set of restrictions does not include a restriction for the turn), the potential restriction may be subject to a manual review process to validate the potential restriction prior to updating the existing/current set of restrictions. In some embodiments, if the review process validates (i.e., confirms) the potential restriction, the existing/current set of restrictions is updated to reflect the restriction. For example, where the manual review confirms a restriction for the northbound left turn from Main St. onto 1^{st} St., the set of restrictions may be updated to include the restriction. Accordingly, a process for automatically identifying and updating traffic restrictions may help to streamline the identification of restrictions as additional scrutiny, such as manual review, may only be required where identified potential restrictions (e.g., identified via an automated process) conflict with existing/current restrictions.

In some embodiments, the resulting restrictions can be used when providing navigational assistance to users. For instance, where a user has requested route guidance from their home to a restaurant, a mapping service may access an existing/current list of traffic restrictions that includes the restriction of the northbound left turn from Main St. onto 1^{st} St., and despite the northbound left turn from Main St. onto 1^{st} St. providing the shortest route to the restaurant, the mapping service may suggest a route having a path straight through the intersection, and an unrestricted U-turn at the next intersection. Thus, the mapping service may route the user around traffic restrictions, including those restrictions identified based on location data obtained from users' mobile devices.

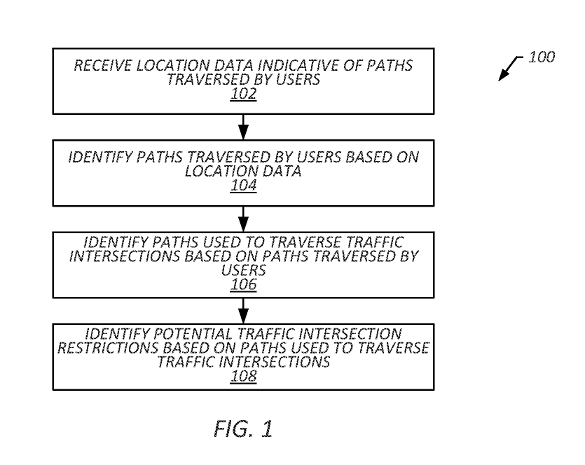

FIG. 1 is a flowchart that illustrates a method 100 of identifying potential traffic intersection restrictions in accordance with one or more embodiments of the present invention. Method 100 may generally include receiving location data indicative of paths traversed by users, identifying paths traversed by the users based at least in part on the received location data, identifying paths used to traverse traffic intersections based at least in part on the identified user paths, and identifying potential traffic intersection restrictions based at least in part on the identified user paths through the traffic intersections. Such a technique may enable identification of potential restrictions for an intersection (e.g., turn restrictions for the intersection) based at least in part on how users have historically traversed the intersection.

Method 100 may include receiving location data indicative of paths traversed by users (block 102). In some embodiments, location data is provided by users' mobile devices, such as users' mobile phones, navigation units, or the like. For example, where a user carries a mobile phone as they travel along a path, the mobile phone may transmit periodic location updates, including geographic location datasets (“geolocation datasets”) (e.g., including latitude and longitude coordinates) corresponding to points along the path. In some embodiments, the geolocation datasets may include positional information (e.g., geographic coordinates), directional information (e.g., vectors indicative of a direction of movement) and/or identifying information (e.g., a unique identifier associated with the user and/or the mobile device). For example, a geolocation dataset may include a position vector that includes geographic coordinates (e.g., latitude and longitude coordinates) and velocity information (e.g., as heading and speed) that corresponds to the movement of the mobile device at the corresponding point in the path, as well as an identifier that identifies the source of the information (e.g., an ID of the mobile device). The velocity information may be derived from the positional information by computing changes to the positional information over a period of time. It may be derived by the mobile device itself, or by a server that receives the positional data from the mobile device. Geolocation datasets may be provided by a global positioning system (GPS) device embedded in the mobile device and/or via other locating techniques, including, for example, triangulation of the mobile device's geolocation using wireless access points. Similar location data may be gathered from any number of user mobile devices to create a set of location data that can be used to identify paths traversed by the users (block 104).

In some embodiments, identifying paths traversed by users based at least in part on the received location data includes grouping geolocation datasets having common identifiers and identifying respective paths based on the groupings. For example, where one-hundred geolocation datasets are collected from a user's mobile device having the ID “1234” (e.g., over a first period of time while the user travels from their home to a restaurant), the geolocation datasets may be grouped under a common track ID “9991”, and used to identify the path that was followed by the user (e.g., the path between the user's home and the restaurant). Any number of paths traversed by any number of users can be so identified based on the location data received from the mobile devices of the users. For example, a second grouping of geolocation datasets associated with a device having the ID “1235” may be grouped under a common track ID “9992”, and used to identify a path from a shopping mall to a gas station. As a further example, where a third grouping of geolocation datasets associated with the device having the ID “1234” is acquired (e.g., over a second period of time while the user travels from the restaurant to a grocery store), the geolocation datasets may be grouped under a common track ID “9993”, and used to identify the path that was followed by the user from the restaurant to the grocery store.

It will be appreciated that, to protect user identity, the geolocation datasets may be anonymized. For example, collected geolocation datasets may be associated and stored with a common track ID, rather than with a known device or person. The groups of data (e.g., track IDs) may only be used for determining a number of times a given path has been traversed, as discussed herein. That is, for example, paths may be used in the aggregate and may not be associated with a particular user, thereby providing a mechanism to help protect user privacy. Moreover, in an effort to protect user privacy, any data that includes a user ID or device ID (e.g., the geolocation datasets) may be stored only temporarily. For example, the individual geolocation datasets may be discarded once a path has been identified or within a given period of time (e.g., three days).

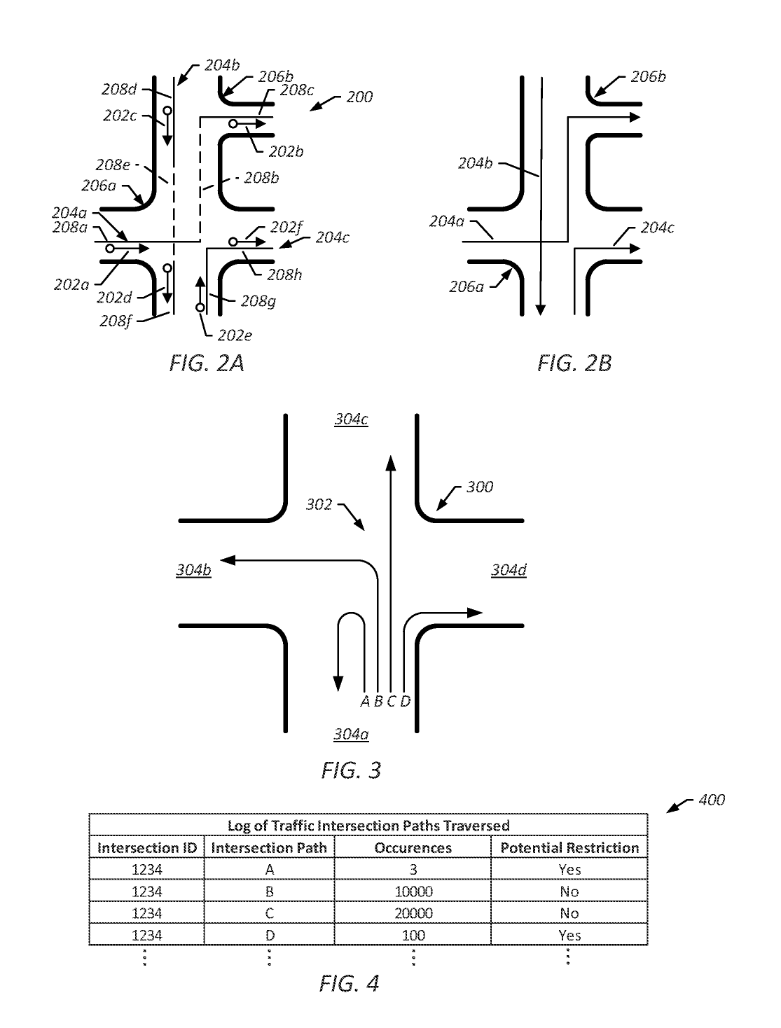

FIG. 2A is a diagram that illustrates an exemplary set of location data 200, including geolocation datasets 202a-f received from a plurality of users. FIG. 2B illustrates an exemplary set of paths 204a-204c (collectively referred to herein as paths 204) identified based on the received location data 202. The illustrated embodiment depicts three paths 204a, 204b and 204c that are traversed by three different users. The first path 204a includes a left turn at a first intersection 206a followed by right turn at a second intersection 206b. The second path 204b includes a straight path through the first and second intersections 206a and 206b. The third path 204c includes a right turn at the first intersection 206a. As depicted, paths 204 are defined by respective path segments 208a-208h (collectively referred to herein as path segments 208). First path 204a includes path segments 208a-208c, second path 204b includes path segments 208d-208f, and third path 204c includes path segments 208g and 208h.

As noted above, location data 202 includes a plurality of geolocation datasets 202a-202f. In some embodiments, geolocation datasets 202a-202f include location information and/or identification information provided by a corresponding mobile device. For example, where a first user traverses the first path 204a while carrying a first mobile device (e.g., a GPS enabled mobile phone) having an ID of “1234”, each of the geolocation datasets 202a and 202b may include geographic coordinates corresponding to their respective illustrated locations and the corresponding ID “1234” (which are associated/grouped under a track ID of “9994”). Where a second user traverses the second path 204b while carrying a second mobile device having an ID of “1235”, each of the geolocation datasets 202c and 202d may include geographic coordinates corresponding to their respective illustrated locations and the corresponding ID “1235” (which are associated/grouped under a track ID of “9995”). Where a third user traverses the third path 204c while accompanied by a third mobile device (e.g., an in-dash GPS navigation unit) having an ID of “1236”, each of the geolocation datasets 202e and 202f may include geographic coordinates corresponding to their respective illustrated locations and the corresponding ID “1236” (which are associated/grouped under a track ID of “9996”).

Each of the respective geolocation datasets may be used to identify a corresponding path segment. For example, path segments 208a, 208c, 208d, 208f, 208g, and 208h may be identified based on geolocation datasets 202a, 202b, 202c, 202d, 202e and 202f, respectively. In some embodiments, the segments may by identified by snapping the geolocation corresponding to the geolocation dataset to a nearest known path segment having a direction that is consistent with the vector information of the geolocation dataset. For example, geolocation dataset 202a may be snapped to segment 208a based on the segment being located close to the geolocation associated with geolocation dataset 202a and segment 208a having a left to right flow of traffic that is consistent with the velocity vector associated with geolocation dataset 202a. A similar snapping technique may be used to identify the segments of the other paths.

In some embodiments, where two segments of a path are not connected (i.e., there is a gap between segments that may be attributed to a lack of location data acquired over a period of time), a gap segment may be identified to complete the path. For example, where path segments 208a and 208c are identified based on geolocation datasets 202a and 202b associated with the ID “1234”, segment 208b may be a gap segment identified to complete path 204. In some embodiments, the gap segment includes one or more segments that provide the shortest, most direct route, between the two adjacent segments of the path. In the illustrated embodiment, another gap segment (e.g., segment 208g) is identified to connect segments 208f and 208h and, thus, complete path 204b. Notably, the illustrated portion of path 204b does not include a gap segment as the two path segments 208c and 208d are adjacent/connected to one another. Returning to FIG. 2B, the exemplary set of resulting paths (e.g., paths 204a-204c) identified based at least in part on the received location data (e.g., geolocation datasets 202a-202f) are illustrated.

Returning now to FIG. 1, method 100 may include identifying paths used to traverse traffic intersections based at least in part on the paths traversed by users (block 106). In some embodiments, identifying paths used to traverse an intersection based at least in part on the paths traversed by users includes identifying an intersection and identifying the paths that enter and exit the intersection. For example, paths 204a-204c may be identified as paths used to traverse intersection 206a, and paths 204a and 204b may be identified as paths used to traverse intersection 206b.

Referring now to FIG. 3, a diagram that illustrates various possible paths 302 (paths “A”-“D”) for traversing an intersection 300, each of paths A-D may be identified as a possible path used to traverse intersection 300 based at least in part on each of the paths passing through an entrance/exit pair of intersection 300. For example, path A is a U-turn path that enters and exits via entrance/exit 304a, path B is a left-turn path that enters intersection 300 via entrance/exit 304a and exits intersection 300 via entrance/exit 304b, path C is a straight path that enters intersection 300 via entrance/exit 304a and exits intersection 300 via entrance/exit 304c, and path D is a right-turn path that enters intersection 300 via entrance/exit 204a and exits intersection 300 via entrance/exit 304d. Although only four paths are depicted for illustrative purposes, it will be appreciated that all possible paths may be identified. For example, a similar set of paths that enter from for each of the other entrance/exits 304b, 304c and 304d may be identified. Although intersection 300 includes a four-way intersection between two streets, for illustrative purposes, the techniques descried herein may be applied to any variety of intersection configurations.

With regard to intersection 300 of FIG. 3, identifying paths used to traverse the intersection may include identifying the particular paths (i.e., A-D) used to traverse intersection 300 and the number of times each of the paths have been traversed over a given period of time (e.g., four weeks). FIG. 4 is a table that illustrates a log 400 of traffic intersection paths traversed in accordance with one or more embodiments of the present invention. Log 400 may include a record of the number of times each of the given paths through intersection 300 has been traversed over a four week period. Log 400 may be derived from the paths used to traverse an intersection as identified at block 106 of method 100. For example, where path 208c of FIG. 2B corresponds to path D of intersection 300, the user traversal of path 204c may be counted as single traversal of path D. Thus, for example, log 400 indicates three vehicles traversing path A over the four week period, ten thousand vehicles traversing path B over the four week period, twenty thousand vehicles traversing path C over the four week period, and one-hundred vehicles traversing path D over the four week period.

Returning again to FIG. 1, method 100 may include identifying potential traffic intersection restrictions based at least in part on the paths used to traverse intersections (block 108). In some embodiments, identifying potential traffic intersection restrictions based at least in part on the paths used to traverse intersections includes, for each of the paths through the intersection (i.e., entering and exiting the intersection), determining whether the path has a potential restriction based at least in part on the number or percentage of times that the path has been traversed. For example, where a given path has been traversed at least a threshold number or percentage of times in a given period (e.g., at least five traversals in a four week period, or given at least 5% of traversals entering from the same intersection entrance or at least 5% of the total traversals of the intersection), it may be determined that the path in not restricted. In contrast, where a given path has not been traversed at least a threshold number or percentage of times in a given period, it may be determined that the path is potentially restricted.

Thus, where a given path is considered to be potentially restricted if it has not been traversed at least five times in a four week period, path A may be identified as being a potentially restricted path based on it only having three occurrences (i.e., three traversals). As a further example, where a given path is considered to be restricted where it has not been traversed for at least 5% of traversals entering from the same intersection entrance, both of paths A and D may identified as being a potentially restricted paths based on their representing less than 5% of the occurrences for paths that enter intersection “1234” 300 via entrance/exit 304a. As depicted at FIG. 4, log 400 may be updated to reflect the potential restrictions of paths A and D,

In some instances, potential restrictions can be compared to existing restrictions for an intersection (i.e., restrictions that have previously been identified for an intersection) to determine whether a conflict exists between the potential and existing restrictions for the intersection.

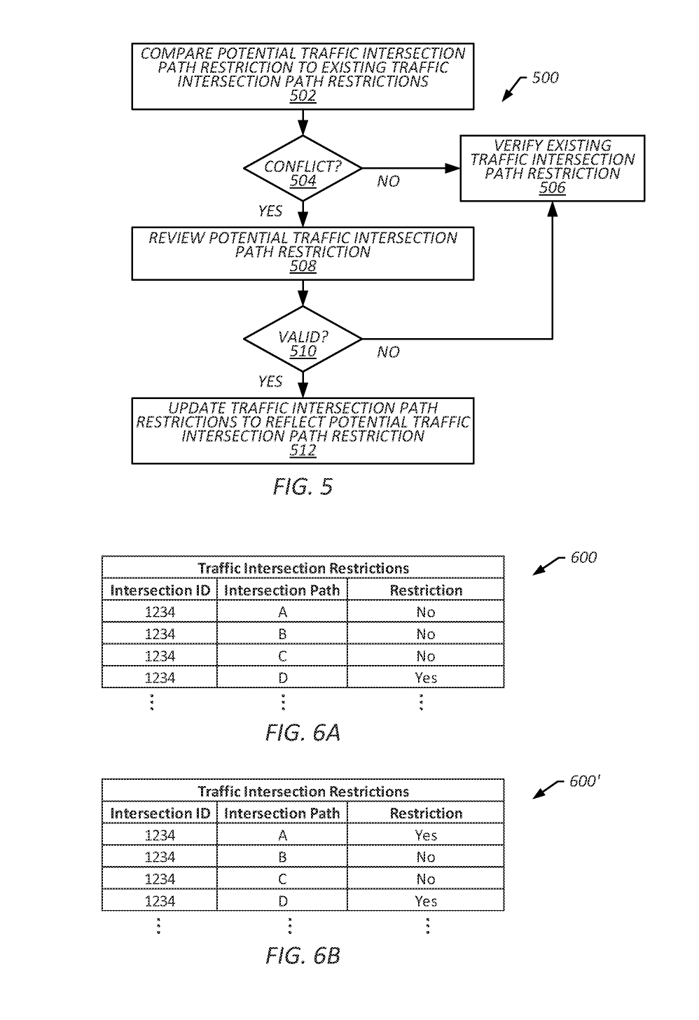

FIG. 5 is a flowchart that illustrates a method 500 of updating traffic intersection restrictions in accordance with one or more embodiments of the present invention. Method 500 may be employed to review some or all of the potential path restrictions that are identified (e.g., via method 100). For example, method 500 may be employed to review each of the potential path restrictions identified for paths A and D depicted in FIG. 3 based on the data in FIG. 4. Method 500 may generally include comparing potential traffic intersection path restrictions to exiting/current traffic intersection restrictions to determine whether or not a conflict exists between the two (blocks 502 and 504). For example, where path D is identified as having a potential path restriction, and it is compared to exiting/current path restrictions for the intersection as depicted in table 600 of FIG. 6A (which indicates a restriction for path D) it may be determined that a conflict does not exists between the potential path restriction for path D and the exiting/current intersection path restrictions. In contrast, where path A is identified as having a potential path restriction, and it is compared to current traffic intersection restrictions of table 600 of FIG. 6A (which does not indicate a restriction for path A) it may be determined that a conflict exists. That is, the potential restriction of path A is not consistent with the existing/current intersection path restrictions that do not include a restriction for path A.

Where it is determined that a conflict does not exist (i.e., where a currently determined set of path restrictions through an intersection agrees with a previously determined set of path restriction through the intersection), the current intersection restrictions may be verified (block 506) and an update to the current intersection restrictions 600 may not be required. For example, where the potential path restriction for path D is already documented in current intersection path restrictions 600, current intersection path restrictions 600 may not be updated. In contrast, where it is determined that a conflict does exist, the potential path restriction may be reviewed to determine whether the potential path restriction is valid (blocks 508 and 510). For example, the potential path restriction of path A may be subject to manual review to determine whether the potential path restriction is valid. In some instances, manual review may include review of satellite images of the intersection to determine if there are any physical barriers that warrant a restriction corresponding to the potential path restriction under consideration, a review of traffic patterns to determine if there is significant traffic congestion at the intersection that warrants a restriction corresponding to the potential path restriction under consideration, and/or the like. Where the potential path restriction is determined to be invalid, the current intersection path restrictions (i.e., the intersection path restrictions already existing in the database) may be verified (block 506) and an update to the current intersection path restrictions 600 may not be required. In contrast, where the potential path restriction is determined to be valid, current intersection path restrictions 600 may be updated to reflect the path restriction. For example, where the review results in a determination that the potential path restriction for path A is warranted, current intersection path restrictions 600 may updated to include a restriction corresponding to the potential path restriction for path A, as depicted in table 600′ of FIG. 6B.

In some embodiments, the current intersection path restrictions can be used when providing navigational assistance to users. For example, where a user requests navigational assistance from their home to a restaurant, and path A (e.g., a U-turn at intersection “1234” or 300) provides the most direct route to the restaurant but is a restricted path, a navigational assistance system may suggest a route that includes path B (e.g., a left turn at intersection “1234” or 300) to provide an unrestricted path to the restaurant.

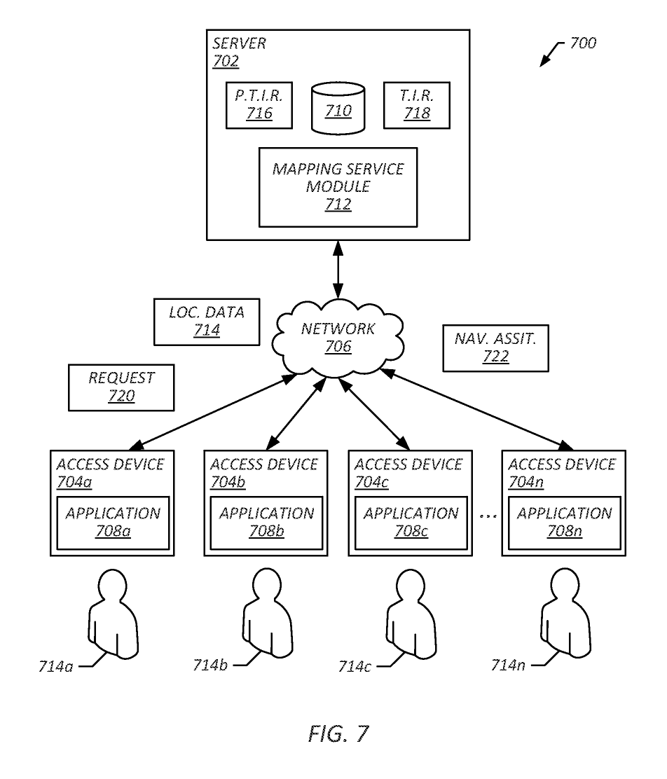

It will be appreciated that methods 100 and 500 are exemplary embodiments of methods that may be employed in accordance with techniques described herein. Methods 100 and 500 may be modified to facilitate variations of its implementations and uses. Methods 100 and 500 may be implemented in software, hardware, or a combination thereof. Some or all of methods 100 and 500 may be implemented by one or more of the modules/applications described herein, such as mapping service module 712, or any of applications 708a-708n depicted and described in more detail below with regard to FIG. 7. For example, mapping service module 712 may implement some or all of the steps described with regard to methods 100 and 500. The order of the steps of methods 100 and 500 may be changed, and various elements may be added, reordered, combined, omitted, modified, etc.

FIG. 7 is a block diagram that illustrates an exemplary mapping service environment 700. Environment 700 includes a server 702 and access devices 704a-704n (collectively referred to herein as access devices 704) communicatively coupled via a network 706.

Network 706 may include an electronic communications network, such as the Internet, a local area network (LAN), a wide area (WAN), a cellular communications network or the like. Network 706 may include a single network or combination of networks.

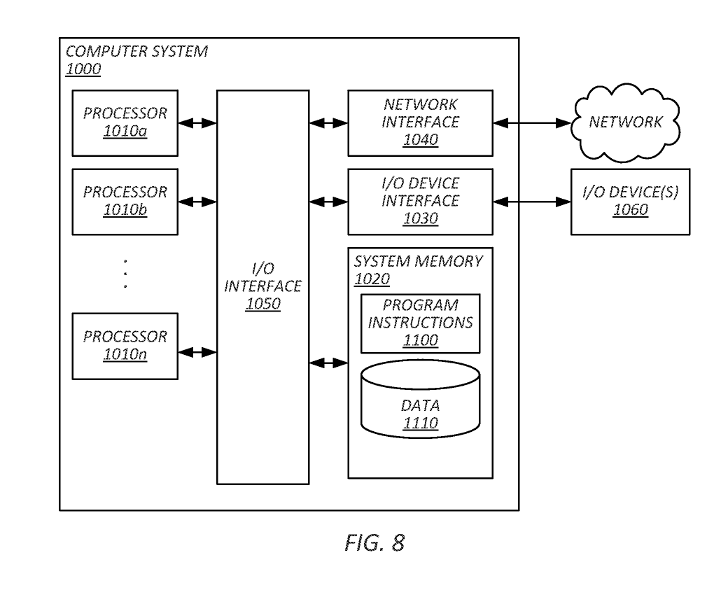

Access devices 704 may include any variety of electronic devices. For example, access devices 704 may include a personal computer (e.g., a desktop computer), a mobile computing device (e.g., a laptop, tablet computer, a cellular phone, a personal digital assistant (PDA), etc.), or the like. In some embodiments, access devices 704 are clients of server 702. In some embodiments, access devices 704 include various input/output (I/O) interfaces, such as a graphical user interface (e.g., display screen), an audible output user interface (e.g., speaker), an audible input user interface (e.g., microphone), a keyboard, a pointer/selection device (e.g., mouse, trackball, touchpad, touchscreen, stylus, etc.), a printer, or the like. In some embodiments, access devices 404 include general computing components and/or embedded systems optimized with specific components for performing specific tasks. In some embodiments, access devices 404 include one or more respective applications 708a-708n (collectively referred to herein as applications 708). In some embodiments, applications 708 include one or more modules having program instructions that are executable by a computer system to perform some or all of the functionality described herein with regard to the respective access devices 704. An application may include, for example, an Internet browser, a mapping application, or similar application that facilitates communication with server 402 and/or other entities of environment 700. In some embodiments, access devices 704 include a computer system similar to that of computer system 1000 described below with regard to at least FIG. 8.

Server 702 may include a network entity that serves requests by client entities. For example, server 702 may serve requests generated by access devices 704. In some embodiments, server 702 hosts a content site, such as a website, a file transfer protocol (FTP) site, an Internet search website or other source of network content. In some embodiments, server 702 includes a mapping server. In some instances, server 702 may serve webpages, maps, navigational information or the like in response to request for navigation assistance generated by access devices 704. In some embodiments, server 702 includes or otherwise has access to data store 710, such as a database or similar data repository.

In some embodiments, server 702 includes a mapping service module 712. Mapping service module 712 may include program instructions that are executable by a computer system to perform some or all of the functionality described herein with regard to a server. For example, mapping service module 712 may include program instructions that are executable by a computer system to perform some or all of the steps of methods 100 and/or 500. In some embodiments, server 702 includes a computer system similar to that of computer system 1000 described below with regard to at least FIG. 8. Although server 702 is represented by a single box in FIG. 7, server 702 may include a single server (or similar system), or a plurality of servers (and/or similar systems). For example, server 702 may include a plurality of different servers (and/or similar systems) that are employed individually or in combination to perform some or all of the functionality described herein with regard to server 702.

In some embodiments environment 700 employs some or all of the techniques described herein. For example, server 402 may receive location data 714 (e.g., geolocation datasets) from access devices 704 of users 714 (e.g., users 714a-714n). Mapping service module 712 may process location data 714 to identify one or more potential traffic intersection restrictions 716 (e.g., as described with regard to method 100). Potential traffic intersection restrictions 716 may be stored at datastore 710. Mapping service module 712 may process potential traffic intersection restrictions 716 and update existing/current traffic intersection restrictions 718 to reflect valid potential traffic intersection restrictions 716 (e.g., as described with regard to method 500). Existing/current traffic intersection restrictions 718 may be stored at datastore 710.

In some embodiments, mapping service module 712 may provide navigational assistance (e.g., maps, route suggestions, route-guidance, or the like) based on traffic intersection restrictions 718. For example, where 708a employs a navigation assistance application 708a to submit request 722 navigational assistance from his/her home to a restaurant, mapping service module 712 may identify a suitable route from the home to the restaurant based at least in part on traffic intersection restrictions 718, and may provide corresponding navigational assistance content 722 (e.g., maps, route suggestions, route-guidance, or the like) for display to user 714a via access device 704a. Although certain embodiments are described with certain entities providing a given set of functionality, embodiments may include any of the functionality described herein being provided by one or more suitable entities. For example, access devices 704 may provide some or all of the functionality of module 712, and/or server 702 may provide some or all of the functionality of applications 708.

Exemplary Computer System

FIG. 8 is a block diagram that illustrates an exemplary computer system 1000 in accordance with one or more embodiments of the present invention. Various portions of systems and methods described herein, may include or be executed on one or more computer systems similar to system 1000. For example, server 702 and/or access devices 704 may include a configuration similar to at least a portion of computer system 1000. Further, methods/processes/modules described herein (e.g., mapping service module 712) may be executed by one or more processing systems similar to that of computer system 1000.

Computer system 1000 may include one or more processors (e.g., processors 1010a-1010n) coupled to system memory 1020, an input/output I/O device interface 1030 and a network interface 1040 via an input/output (I/O) interface 1050. A processor may include a single processor device and/or a plurality of processor devices (e.g., distributed processors). A processor may be any suitable processor capable of executing/performing instructions. A processor may include a central processing unit (CPU) that carries out program instructions to perform the basic arithmetical, logical, and input/output operations of computer system 1000. A processor may include code (e.g., processor firmware, a protocol stack, a database management system, an operating system, or a combination thereof) that creates an execution environment for program instructions. A processor may include a programmable processor. A processor may include general and/or special purpose microprocessors. A processor may receive instructions and data from a memory (e.g., system memory 1020). Computer system 1000 may be a uni-processor system including one processor (e.g., processor 1010a), or a multi-processor system including any number of suitable processors (e.g., 1010a-1010n). Multiple processors may be employed to provide for parallel and/or sequential execution of one or more portions of the techniques described herein. Processes and logic flows described herein may be performed by one or more programmable processors executing one or more computer programs to perform functions by operating on input data and generating corresponding output. Processes and logic flows described herein may be performed by, and apparatus can also be implemented as, special purpose logic circuitry, e.g., an FPGA (field programmable gate array) or an ASIC (application specific integrated circuit). Computer system 1000 may include a computer system employing a plurality of computer systems (e.g., distributed computer systems) to implement various processing functions.

I/O device interface 1030 may provide an interface for connection of one or more I/O devices 1060 to computer system 1000. I/O devices may include any device that provides for receiving input (e.g., from a user) and/or providing output (e.g., to a user). I/O devices 1060 may include, for example, graphical user interface displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote geolocation. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area (WAN), a cellular communications network or the like.

System memory 1020 may be configured to store program instructions 1100 and/or data 1110. Program instructions 1100 may be executable by a processor (e.g., one or more of processors 1010a-1010n) to implement one or more embodiments of the present technique. Instructions 1100 may include modules of computer program instructions for implementing one or more techniques described herein with regard to various processing modules. Program instructions may include a computer program (also known as a program, software, software application, script, or code). A computer program may be written in any form of programming language, including compiled or interpreted languages, or declarative/procedural languages. A computer program may include a unit suitable for use in a computing environment, including as a stand-alone program, a module, a component, a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier. A tangible program carrier may include a propagated signal and/or a non-transitory computer readable storage medium. A propagated signal may include an artificially generated signal (e.g., a machine generated electrical, optical, or electromagnetic signal) having encoded information embedded therein. The propagated signal may be transmitted by a suitable transmitter device to and/or received by a suitable receiver device. A non-transitory computer readable storage medium may include a machine readable storage device, a machine readable storage substrate, a memory device, or any combination thereof, or the like. Non-transitory computer readable storage medium may include, non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium having program instructions stored thereon that are executable by a computer processor (e.g., one or more of processors 1010a-1010n) to cause some or all of the subject matter and the functional operations described herein. A memory (e.g., system memory 1020) may include a single memory device and/or a plurality of memory devices (e.g., distributed memory devices).

I/O interface 1050 may be configured to coordinate I/O traffic between processors 1010a-1010n, system memory 1020, network interface 1040, I/O devices 1060 and/or other peripheral devices. I/O interface 1050 may perform protocol, timing or other data transformations to convert data signals from one component (e.g., system memory 3020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000, or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices and/or software that may perform or otherwise provide for the performance of the techniques described herein. For example, computer system 1000 may include a desktop computer, a laptop computer, a tablet computer, a server device, a client device, a mobile telephone, a personal digital assistant (PDA), a mobile audio or video player, a game console, a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” may include a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

1. A computer-implemented method for determining restrictions at an intersection of two roads, comprising:
receiving location data from one or more devices used to traverse the intersection via a plurality of paths;
identifying the plurality of paths through the intersection from the location data;
classifying each of the plurality of paths through the intersection according to a type of path through the intersection;
obtaining a count for a type of path through the intersection based on the plurality of classified paths;
identifying a potential restriction for the type of path through the intersection based at least in part on the count of the plurality of paths of that type used to traverse the intersection; and
storing the potential restriction for that type of path through the intersection in association with map feature data for the intersection.

2. The method of claim 1, further comprising:
comparing the potential restriction to existing restrictions for the traffic intersection to determine whether the potential restriction conflicts with the existing restrictions for the traffic intersection; and
in response to determining that the potential restriction does not conflict with the existing restrictions for the traffic intersection, maintaining the existing restrictions for the traffic intersection.

3. The method of claim 1, further comprising:
comparing the potential restriction to existing restrictions for the traffic intersection to determine whether the potential restriction conflicts with the existing restrictions for the traffic intersection; and
in response to determining that the potential restriction conflicts with the existing restrictions for the traffic intersection, updating the existing restrictions for the traffic intersection to reflect the potential restriction.

4. The method of claim 1, wherein identifying the plurality of paths through the intersection from the location data comprises grouping the location data according to a given time period and a common identifier associated therewith.

5. The method of claim 1, wherein classifying each of the plurality of paths through the intersection according to a type of path through the intersection comprises classifying each of the plurality of paths according to an entrance and an exit of the intersection.

6. The method of claim 1, wherein identifying a potential restriction for the type of path through the intersection based at least in part on the count of the plurality of paths of that type used to traverse the intersection comprises identifying a potential restriction for the traffic intersection based at least in part on a number of times the path has been traversed

7. The method of claim 1, wherein identifying a potential restriction for the type of path through the intersection based at least in part on the count of the plurality of paths of that type used to traverse the intersection comprises:
comparing the count obtained over a given period of time to a threshold; and
in response to determining that the count is less than the threshold value, determining that the type of path corresponds to a potential path restriction for the intersection

8. The method of claim 1, wherein identifying a potential restriction for the type of path through the intersection based at least in part on the count of the plurality of paths of that type used to traverse the intersection comprises:
determining, from a plurality of counts of all types of paths through the intersection, a percentage of the type of path through the intersection; and
determining that the type of path corresponds to a potential path restriction when the percentage is less than a threshold.

9. The method of claim 1, further comprising:
receiving a request for navigational assistance;
providing navigational assistance that directs a user away from the potential path restriction.

10. The method of claim 1, further comprising:
receiving a request for navigational assistance;
identifying a route that includes the potential path restriction;
identifying an alternate route that does not include the potential path restriction; and
providing navigational assistance corresponding to the alternate route.

11. A system comprising:
one or more memories storing instructions; and
one or more processors coupled to the one or more memories and configured to execute the instructions stored thereon to perform the following steps for determining turn restrictions at an intersection of two roads:
receiving location data indicative of obtained from one or more devices used to traverse the intersection via a plurality of paths traversed used to traverse the intersection by a plurality of users;
identifying paths traversed by users based on the received location data;
identifying a subset of the plurality of paths used to traverse a traffic through the intersection from the location data;
classifying each of the plurality of paths through the intersection according to a type of path through the intersection;
obtaining a count for a type of path through the intersection based on the plurality of classified paths;
identifying a potential turn restriction for the type of path through the traffic intersection based at least in part on the subset of the count of the plurality of paths of that type used to traverse the traffic intersection; and
storing the potential restriction for that type of path through the intersection in association with the traffic map feature data for the intersection.

12. A non-transitory computer readable medium comprising program instructions stored thereon that are executable by a processor to cause the following steps for determining turn restrictions at an intersection of two roads:
receiving location data indicative of obtained from one or more devices used to traverse the intersection via a plurality of paths traversed used to traverse the intersection by a plurality of users;
identifying paths traversed by users based on the received location data;
identifying a subset of the plurality of paths used to traverse a traffic through the intersection from the location data;
classifying each of the plurality of paths through the intersection according to a type of path through the intersection;
obtaining a count for a type of path through the intersection based on the plurality of classified paths;
identifying a potential turn restriction for the type of path through the traffic intersection based at least in part on the subset of the count of the plurality of paths of that type used to traverse the traffic intersection; and
storing the potential restriction for that type of path through the intersection in association with the traffic map feature data for the intersection.
